(19) United States
(12) Patent Application Publication
(10) Pub. No.: US 2020/0062468 A1
(43) Pub. Date: Feb. 27, 2020

(54) APPARATUS FOR AN IMPROVED HPP JAR

(71) Applicants: Gary Deslauriers, Rock Island, IL (US); Hoyt Diehl, Rock Island, IL (US)

(72) Inventors: Gary Deslauriers, Rock Island, IL (US); Hoyt Diehl, Rock Island, IL (US)

(21) Appl. No.: 16/109,303

(22) Filed: Aug. 22, 2018

(51) Int. Cl. B65D 51/14; A23L 3/015

(52) U.S. Cl. CPC B65D 51/145; A23L 3/0155

(57) ABSTRACT

A food preparation jar. The jar has a jar that accepts a lid. The lid having grooves inside to couple with the grooves on the upper portion of the jar. The lid further having a sealing ring that provides a secure and air-tight seal when the jar is heated and cooled.

### FIELD OF THE INVENTION

This invention relates to methods and apparatus for canning food products. More particularly, it relates to method and apparatus which are suitable for use in home canning operations.

### BACKGROUND

Home canning of various types of produce, such as fruits and vegetables, has become a popular activity in the United States. While there are many attractive reasons for such home canning, a major disadvantage to the procedure has always been the necessity for pressure cooking the food product within the container. This process has generally involved preparing the food products and placing them in containers, such as glass jars with loosely closed tops, and then placing the container and product within a pressure cooking jar, or retort, and then applying steam to the containers and their contents for an extended period of time within the pressure cooker, to cook and sterilize the food.

A variety of methods are in use in the canning, preserving, and food processing field, both in industry and in the home, for closing and hermetically sealing containers, such as Mason jars. The advantages and disadvantages of any particular sealing method are determined by such factors as the cost of the containers and closures, the nature of the product to be canned, convenience to the users, and economies achieved by mass production. The advantages and disadvantages of a number of these methods are discussed below.

One early method employed a metal screw cap having a porcelain inner linear adapted to be used with a thin, flat annular rubber gasket to seal the mouth of the conventional Mason jar. After sterilization, the annular rubber gasket is placed on the sealing rim of the jar to be sealed. The metal cap is screwed tight and then turned back about one-quarter of a turn.

The container and its contents are then processed, using either steam pressure or boiling water in the conventional manner depending in part on the product to be canned. During the processing cycle, the hot gases formed within the container are vented over the gasket and out under the cap. Immediately after processing and while the container and its contents remain hot, the metal screw cap is firmly tightened upon the rubber gasket to form the hermetic seal.

Another technique is the plated screw cap with a plastic annular inner liner or ridge. This cap is adapted to be tightly screwed into position over the mouth of the container to achieve a pressure sealing contact with the rim of the container. The processing and venting procedure is the same as described above with the early porcelain lined caps, and the plastic annular liner must be hermetically sealed to the inside of the cap if an acceptable seal is to be achieved.

The advantage of this sealing method is the ease of reclosing the container after the original seal has been broken to provide protection for a limited period of time to the contents of the container until such contents are consumed. The relatively low cost of these plastic lined caps justifies their disposed after use and their re-use generally is not recommended due to degradation of the liner.

In the canning of certain types of products, where the item has a natural immunity to spoilage or has been treated to resist deterioration, metal screw caps with coated cardboard inserts are used. While the seal between the cardboard insert and the rim of the jar may not be entirely secure over a long period of time, its low cost makes this technique attractive. This apparatus is not acceptable for canning.

A related technique is the use of a thin, non-porous paper which is placed over the open mouth of and cemented to the rim of the container. A metal screw cap placed over the sealed container protects the thin paper closure. The low cost of this technique for sealing certain products accounts for its wide popularity, but again it is not suitable for canning.

A widely used method of canning in the food processing industry employs the self-sealing, metal lid with an annular inner sealant or adhesive. The acceptance of this technique is based upon its low cost and upon the ease by which the container may be hermetically sealed in an automatic or semi-automatic fashion during the normal processing cycle. The metal lid is formed as a thin disk having a slightly rolled edge adapted to surround the open mouth of the container adjacent the rim to prevent lateral movement of the lid. A ring of heat-sensitive sealant or adhesive is applied to the inner surface of the metal lid adjacent its perimeter to provide for a sealing contact with the rim of the container. The cleaned metal lid is placed upon the jar to be sealed and a screw band or annular clamp is fastened in place. The jar with its contents is then processed in the conventional manner. After processing, the sealed jar is left to stand overnight. By virtue of the slow cooling of the jar and its contents, the pressure reduces within the jar causing the lid to be retained against the rim and the hermetic seal to be maintained. After the jar has cooled, the screw band may be removed.

### BRIEF DESCRIPTION OF THE DRAWINGS

FIG. 1 is a view an exemplary container or jar.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

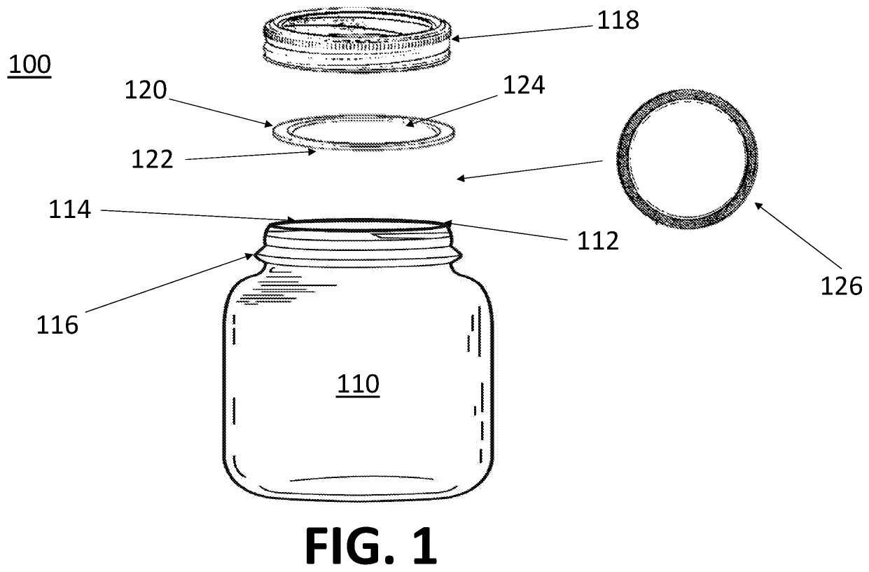

Referring to FIG. 1, a conventional container or jar 110 having an open mouth 112 and a smooth, flat annular rim 114 is illustrated in perspective as representative of one type of container with which the present invention is particularly adapted to be employed.

Container 110 is provided with threads 116 for engaging the threads of the conventional screw band or ring 118. The container or jar 110 may be made of any material such as glass, tempered glass, high temperature plastic, etc. The container or jar 110 may be of any size and of any shape such as a mason jar, Ball® jar, etc.

The open mouth 112 of container 110 is adapted to be hermetically sealed by the lid 120, which in this first embodiment is a thin, flat disk having a lower or inner surface 122 and an upper or outer surface 124. A seal 126 is placed over the open mouth 112 and in contact with the rim 114. The seal 126 may be EPBM rubber, Polyethylene Terephthalate (PET), etc.

The lid 120 is placed onto the seal 126 over the open mouth 112 and in contact with rim 114 before the screw band 116 is applied or, alternatively, the lid 120 may be placed in the band 118, before the band 118 is partially screwed onto the container 110 prior to processing and sealing.

Lid 120 may take a variety of forms, each of which possesses the characteristics that have been found to provide the improved hermetic seal. A hermetic seal as used herein includes a vacuum seal. The inner surface 122 of the lid 120 is composed of a non-porous material extending over the entire inner surface 122 of the lid 120.

The portion of the inner surface 122 adjacent the perimeter of the lid 120 is composed of an elastomeric material having a resilient and pliable characteristic particularly adapted to be depressed by the annular rim 114 to provide a hermetic seal and to return to its original elastomeric characteristic when the lid 120 has been removed from service.

The non-porous elastomeric material extends over the entire inner surface 122 of lid 120, including the portion adjacent the perimeter of the lid 120. Polyisoprene has been found to possess the desirable nonporous, elastomeric, and heat resistant characteristics to form the inner surface 122. Polyisoprene is a type of synthetic rubber made by polymerizing isoprene and has the same basic composition as natural rubber.

The central portion of lid 120 possesses a semi-rigid though deflectable characteristic which is adapted to be drawn partially inward into the open mouth of the container when the pressure within container 110 is less than the pressure external to container 110.

This pressure differential occurs during the conventional food processing cycle as the container 110 and its contents are cooled. Proper selection of the material, such as polypropylene, for the central portion of the outer layer 124 of lid 120 will permit a deflection sufficient to provide a visual indication of the existence of this pressure differential which is necessary to provide and maintain a hermetic seal, while at the same time preventing the lid from collapsing into the container.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. (canceled)

2. The food preparation container of claim 12 wherein when the jar is heated the ring expands and forms an airtight seal with the jar.

3. The food preparation container of claim 12, wherein when the jar is heated and cooled, the inner ring expands and becomes rigid to form an air-tight lock.

4. The food preparation container of claim 12, wherein the inner ring being rubber.

5. The food preparation container of claim 12, where the inner ring being Ethylene Propylene (EPDM).

6. The food preparation container of claim 12, wherein the jar is Polyethylene terephthalate (PET).

7. The food preparation container of claim 12, wherein the jar being glass.

8. (canceled)

9. The food preparation container of claim 12 wherein the jar contains a food product.

10. The food preparation container of claim 12, wherein the food product is fruit.

11. The food preparation container of claim 12 wherein the jar being a mason jar.

12. A food preparation container, the container comprising:
a jar, the jar having an open mouth and threads, wherein the threads being for engaging a screw band or an inner ring;
a flat annular rim;
the inner ring, the seal being coupled to the open mouth of the jar, wherein the inner ring being coupled to the rim, and wherein the inner ring forms a secure seal with the jar;
a lid, the lid having a screw band, wherein the lid being placed onto the inner ring and the lid being in contact with the rim, wherein the screw band being coupled to the threads of the container; and
a non-porous elastomeric material being extended over an entire inner surface of the lid.
